(19) United States
(12) Patent Application Publication
(10) Pub. No.: US 2025/0242487 A1
(43) Pub. Date: Jul. 31, 2025

(54) ROBOTIC GRIPPING DEVICE

(71) Applicant: Research Foundation of the City University of New York, New York, NY (US)

(72) Inventors: Alan M. Shih, Closter, NJ (US); Inigo Sanz-Pena, New York, NY (US)

(21) Appl. No.: 19/041,730

(22) Filed: Jan. 30, 2025

Related U.S. Application Data
(60) Provisional application No. 63/626,617, filed on Jan. 30, 2024.

(51) Int. Cl. B25J 9/14

(52) U.S. Cl. CPC B25J 9/142

(57) ABSTRACT

A robotic gripping device with a flexible, elongated core and a hollow interior. Bellows protrude radially from the elongated core. The interior is inflated and/or deflated to produce a predetermined motion based on the configuration of the bellows.

### CROSS-REFERENCE TO RELATED APPLICATIONS

This application claims priority to, and is a non-provisional of, U.S. Patent Application 63/626,617 (filed Jan. 30, 2024), the entirety of which is incorporated herein by reference.

### STATEMENT OF FEDERALLY SPONSORED RESEARCH OR DEVELOPMENT

This invention was made with Government support under grant number NASAMPLAN2024 awarded by the National Aeronautics and Space Administration. The government has certain rights in the invention.

### BACKGROUND OF THE INVENTION

The subject matter disclosed herein relates to robotic gripping devices and more specifically to robotic gripping devices with pneumatic or hydraulic actuation.

Robotics is a rapidly developing technology that has driven fast-pace economic development in recent decades with its ubiquitous applications. There have been numerous designs for a robotic arm with grippers to reach and grasp an object to perform a set of tasks. The gripping apparatus can be a rigid gripping jaw, a more sophisticated finger-like configuration, or the so-called “soft robotics”, which incorporates flexible materials for the robotic grippers that could conform to and pick up a wide variety of objects.

Soft robotics is a relatively new branch of robotics development. They can be mechanically, electrically, hydraulically, or pneumatically operated with a soft shell whose geometry can be altered with the manipulation of the actuation mechanism. Such controlled geometric morphing achieves desired motions to achieve the gripping functionality. Such a soft gripper can better handle delicate and odd-shaped objects.

While existing robotic gripping devices allow grippers to bend and grab objects, the range of motion of such devices is limited. An improved robotic gripping device is therefore desired. The discussion above is merely provided for general background information and is not intended to be used as an aid in determining the scope of the claimed subject matter.

### SUMMARY

This disclosure provides a robotic gripping device with a flexible, elongated core and a hollow interior. Bellows protruding radially from the elongated core. The interior is inflated and/or deflated to produce a predetermined motion based on the configuration of the bellows.

In a first embodiment, a robotic gripping device is provided. The robotic gripping device comprising: an elongated core with a longitudinal axis, the elongated core being flexible; a plurality of bellows protruding radially from the elongated core to define a spanning angle (θ) about a circumference of the elongated core, the plurality of bellows being flexible; a fluid port; and a hollow interior extending through the elongated core and into each bellow in the plurality of bellows, the hollow interior fluidly connected to the fluid port such that the hollow interior is inflated by adding fluid and deflated by removing fluid, thereby actuating the plurality of bellows.

In a second embodiment, a device is provided. The device comprising a first robotic gripping device and a second robotic gripping device, each robotic gripping device comprising: an elongated core with a longitudinal axis, the elongated core being flexible; a plurality of bellows protruding radially from the elongated core to define a spanning angle about a circumference of the elongated core, the plurality of bellows being flexible; a fluid port; and a hollow interior extending through the elongated core and into each bellow in the plurality of bellows, the hollow interior fluidly connected to the fluid port such that the hollow interior is inflated by adding fluid and deflated by removing fluid, thereby actuating the plurality of bellows.

In a third embodiment, a device is provided. The device comprising a first robotic gripping device, a second robotic gripping device and a third robotic gripping device, each robotic gripping device comprising: an elongated core with a longitudinal axis, the elongated core being flexible; a plurality of bellows protruding radially from the elongated core to define a spanning angle about a circumference of the elongated core, the plurality of bellows being flexible; a fluid port; and a hollow interior extending through the elongated core and into each bellow in the plurality of bellows, the hollow interior fluidly connected to the fluid port such that the hollow interior is inflated by adding fluid and deflated by removing fluid, thereby actuating the plurality of bellows; wherein the hollow interiors of the first robotic gripping device, the second robotic gripping device and the third robotic gripping device are simultaneously inflated or deflated by the fluid.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A is a schematic depiction of a robotic gripping device in a neutral position.

FIG. 1B depicts the robotic gripping device in an inflated position gripping an object.

FIG. 2 is a schematic depiction of the robotic gripping device with modular sections labeled.

FIG. 3A and FIG. 3B are plan views of two embodiments of a section for use in the robotic gripping device.

FIG. 3C is a cross-section view of one embodiment of a robotic gripping device.

FIG. 3D and FIG. 3E are plan views of two other embodiments of a section for use in the robotic gripping device.

FIG. 3F is a depiction of one geometric description of a bellow.

FIG. 4A is an end view of an expanding section for use in the robotic gripping device.

FIG. 4B is a perspective view of an expanding section for use in the robotic gripping device in a neutral position.

FIG. 4C depicts the expanding section in an inflated position.

FIG. 5A is an end view of a bending section for use in the robotic gripping device.

FIG. 5B is a perspective view of a bending section for use in the robotic gripping device.

FIG. 5C depicts the bending section in an inflated position gripping an object.

FIG. 6A is an end view of a curling section for use in the robotic gripping device.

FIG. 6B is a perspective view of a curling section for use in the robotic gripping device in a neutral position.

FIG. 6C depicts the curling section in an inflated position gripping an object.

FIG. 7A is a perspective view of a first spiraling section for use in the robotic gripping device in a neutral position.

FIG. 7B is a perspective view of a second spiraling section for use in the robotic gripping device in a neutral position.

FIG. 8A is a perspective view of a third spiraling section for use in the robotic gripping device in a neutral position.

FIG. 8B is a perspective view of the third spiraling section in an inflated position.

FIG. 9A is a perspective view of one embodiment of a robotic gripping device.

FIG. 9B is a schematic depiction of the resulting motion produced by the robotic gripping device.

### DETAILED DESCRIPTION OF THE INVENTION

The disclosed pneumatically or hydraulically controlled soft robotic arms provide a better means to grab irregularly shaped or delicate objects compared to their counterparts with rigid phalanges. Current soft robotic arms have limitations in their abilities in extension to reach distant objects, or curl and wrap helically around an object with a more secure and versatile grip, or both. Many cannot achieve gripping capability with a single arm. The disclosed robotic gripping devices have improved capabilities in these features.

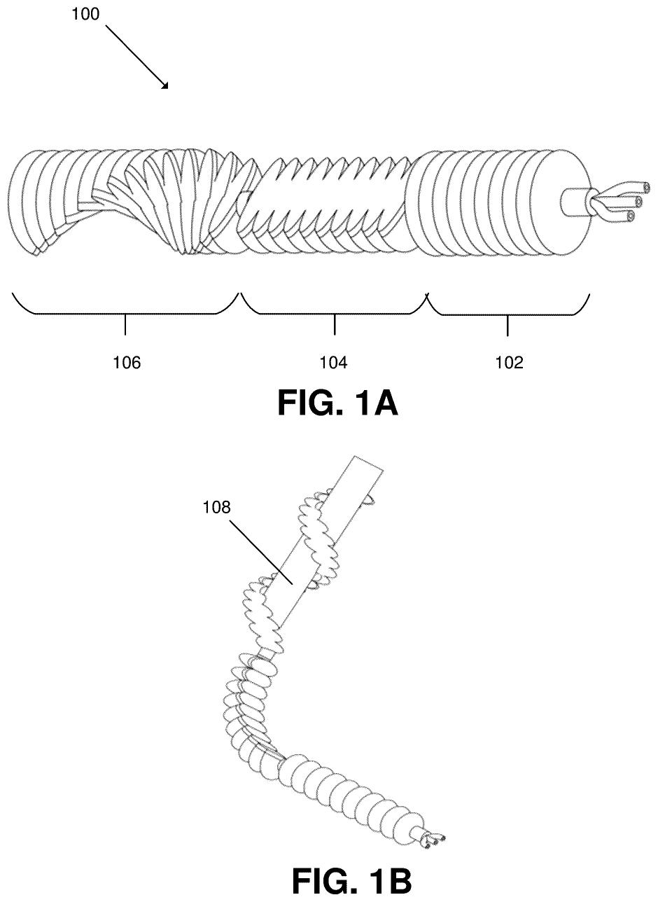

FIG. 1A depicts one embodiment of a robotic gripping device 100 in a neutral position. A neutral position is a position wherein the device has not been inflated or deflated (i.e. internal pressure of 1 atmosphere). FIG. 1B depicts the embodiment of FIG. 1A after actuation and gripping an object 108.

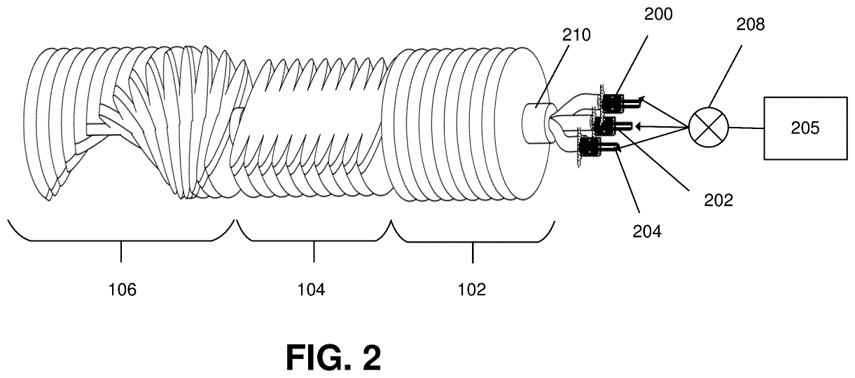

As illustrated in FIG. 1A, the robotic gripping device 100 is modular such that one or more sections are present. Examples of such sections include an expanding section 102, a bending section 104 and a curling section 106. One or more sections can be present by themselves or in any combination of sections. In one embodiment, at least two sections are present, each mechanically connected to an adjacent section. As shown in FIG. 2, the robotic gripping device 100 is fluidly connected to a fluid source 205 such that a predetermined section is selectively inflated or deflated by actuation of a corresponding controller (e.g. controller 200, controller 202 and/or controller 204). By way of illustration, and not limitation, the controller 200 may be actuated such that pressurized fluid is added to, or removed from, the curling section 102. The controller 202 may be actuated such that pressurized fluid from the fluid source 205 is added to, or removed from, the bending section 104 to produce a bending motion. The controller 204 may be actuated such that pressurized fluid to added to, or removed from, the expanding section 106.

In some embodiments, the fluid source 205 is present that can pump the fluid into, or out of, the curling section 106, the bending section 104 and the expanding section 102 through the controller 200, the controller 202, and the controller 204, respectively, to inflate or deflate the respective section. Each section in the robotic gripping device 100 is configured in a similar manner such that each section can be independently inflated or deflated, thereby producing a wide range of motions. They can also share the same controller to be inflated or deflated together. The fluid in fluid source 205 may be a gas (e.g. air, nitrogen, etc.) or a liquid (e.g. water, an aqueous solution, antifreeze, etc.) and pumping direction may be controlled by a pump 208. Due to the modular nature of the sections, two or more sections can be mechanically connected in series in a variety of configurations (e.g. two adjacent bending sections, three adjacent bending sections, two adjacent bending sections followed by a curling section, etc.).

The robotic gripping device is mounted to a fixed point 210. The fixed point 210 provides an anchor such that a gripped object is moved relative to the fixed point 210. The fixed point 210 may be anchored to a stationary structure (e.g. a stationary mounting such as on an assembly line) or a mobile platform (e.g. mounted to a vehicle such as an automotive vehicle or robot). Actuation of the inflation and deflation of each section can be manually controlled by a human user or may be controlled by a computer (not shown).

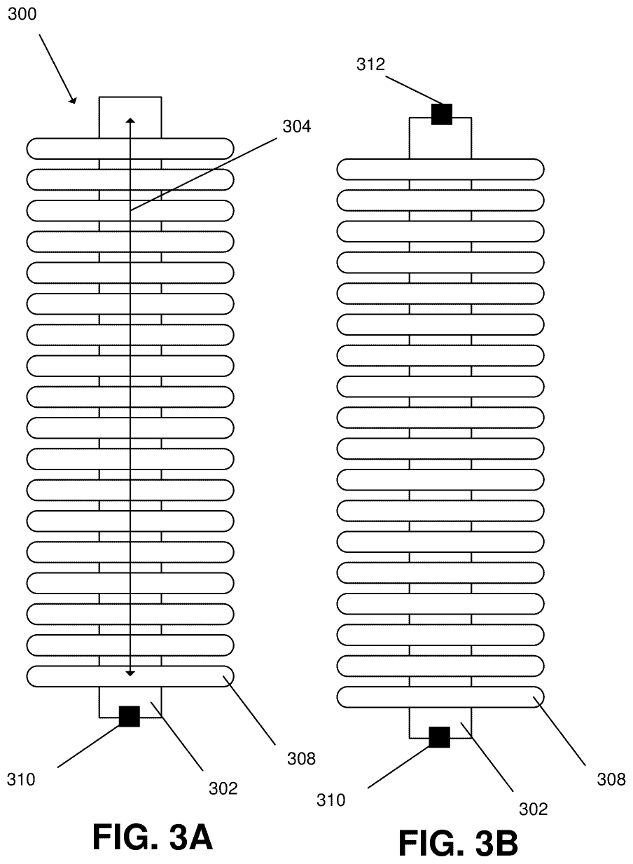

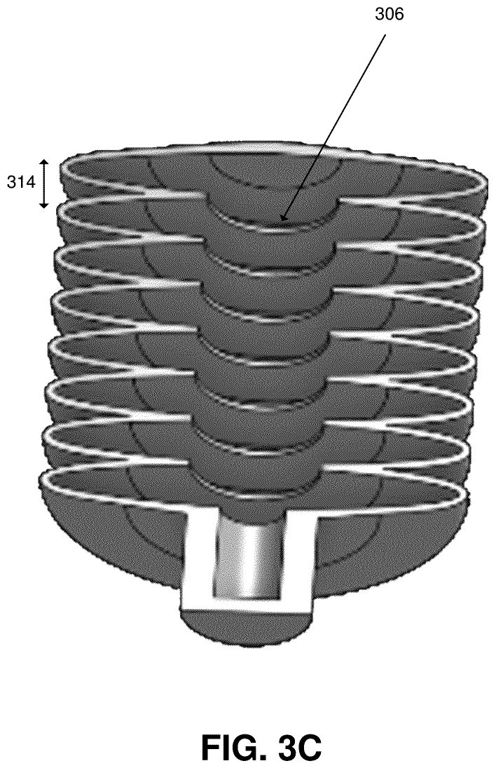

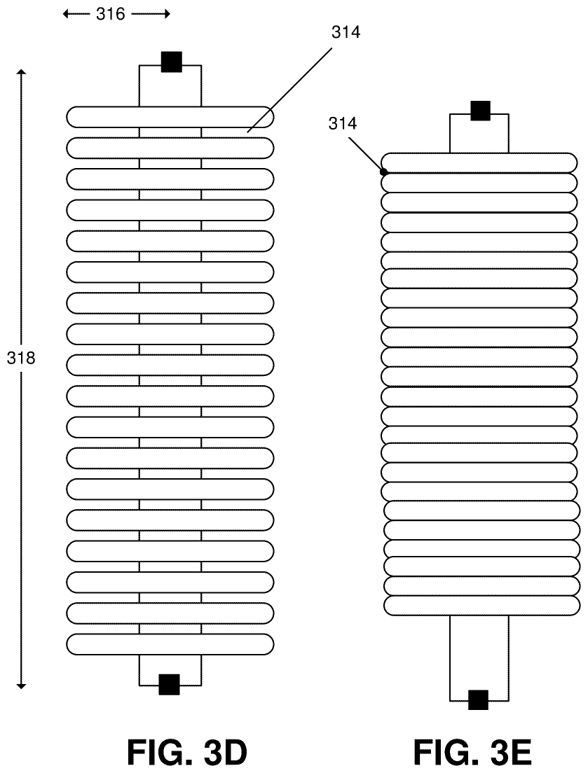

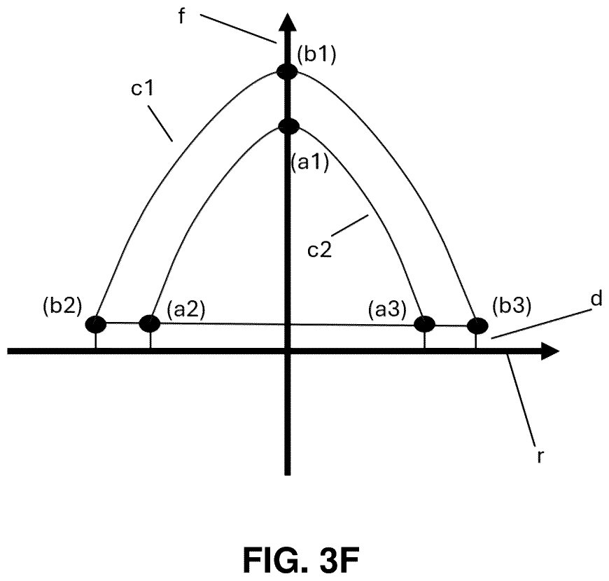

FIG. 3A and FIG. 3B depicts two embodiments of a section. FIG. 3A depicts a section 300 that comprises an elongated core 302 with a longitudinal axis 304. The elongated core 302 is flexible (e.g. a durometer hardness rating of 30 Shore A scale or lower or 40 Shore A or lower and may be formed from a suitably flexible material such as a rubber (e.g. silicon rubber), etc. The elongated core 302 comprises a hollow interior 306 (not shown in FIG. 3A, but see FIG. 3C). The section 300 further comprises a plurality of bellows 308 that protrude radially from the elongated core 302. Like the elongated core 302, the plurality of bellows 308 are flexible and may be formed of a rubber material.

The bellows provide pocket chamber for receiving the fluid. In one embodiment, and with reference to FIG. 3F, the bellows have a shape defined by two two-dimensional curves (c1, c2) on a plane that is perpendicular to an axis of revolution (r) that each connects an apex point (a1, b1) along an axis of symmetry (f) with two base points each (a2, a3 and b2, b3). Base points are offset from the axis of revolution by a distance (d). These two curves (c1, c2) form the wall thickness of the bellow. The curves c1, c2 revolve around the axis of revolution (r) to form the geometry of a bellow. Curves cl and c2 can be any two-dimensional geometric curves, including straight lines.

In one embodiment, the elongated core 302 and the plurality of bellows 308 are formed of the same material and are monolithic. A fluid port 310 is present on a proximate end of the elongated core 302 for receiving the controller 200, the controller 202, or the controller 204 (see FIG. 2). In the embodiment of FIG. 3A, the distal end of the elongated core 302 is capped. The capped distal end may have a receptacle for receiving a connector but the cap prevents fluid connection to the hollow interior 306. In contrast, in the embodiment of FIG. 3B, the distal end of the elongated core 302 comprises a second fluid port 312 which may also receive a connector to further connect to another section. FIG. 3C depicts the hollow interior 306 in further detail. The hollow interior 306 extends through the elongated core and into each bellow.

Each bellow is spaced from an adjacent bellow by a gap 314 (see FIG. 3D and FIG. 3E) at a distal end of the respective bellows. The gap 314 may be, for example, greater than 0 but less than 1 cm, less than 50 mm or less than 5 mm. Each bellow protrudes from the elongated core by a length 316 which is generally from 5 mm to 10 cm, from 5 mm to 5 cm, from greater than 0 mm to 10 cm, or from 5 mm to 1 cm. The robotic gripping device may have a length 318 which is not particularly limited. Examples include a length 318 from 1 cm to 5 m, from 1 cm to 50 cm, or from 1 cm to 5 cm. The length 318 refers to the length when the pressure within the bellows is 1 atmosphere.

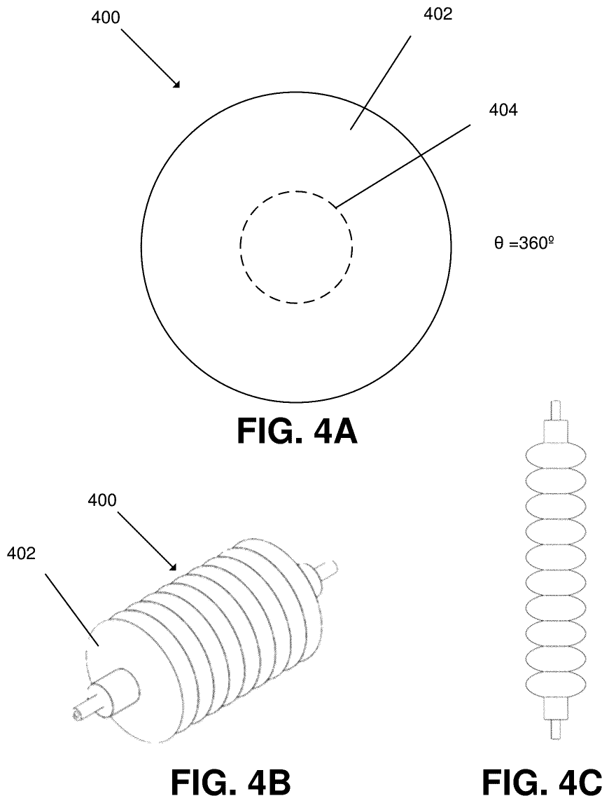

Referring to FIG. 4A, FIG. 4B and FIG. 4C, an expanding section 400 is illustrated that comprises a plurality of bellows 402 that protrude radially from an elongated core 404 to define a spanning angle (θ) about a circumference of the elongated core 404. In the embodiment of FIG. 4A, the spanning angle (θ) is 360°. As shown in FIG. 4C, when a fluid is added to the hollow interior, the plurality of bellows 402 expands along the longitudinal axis.

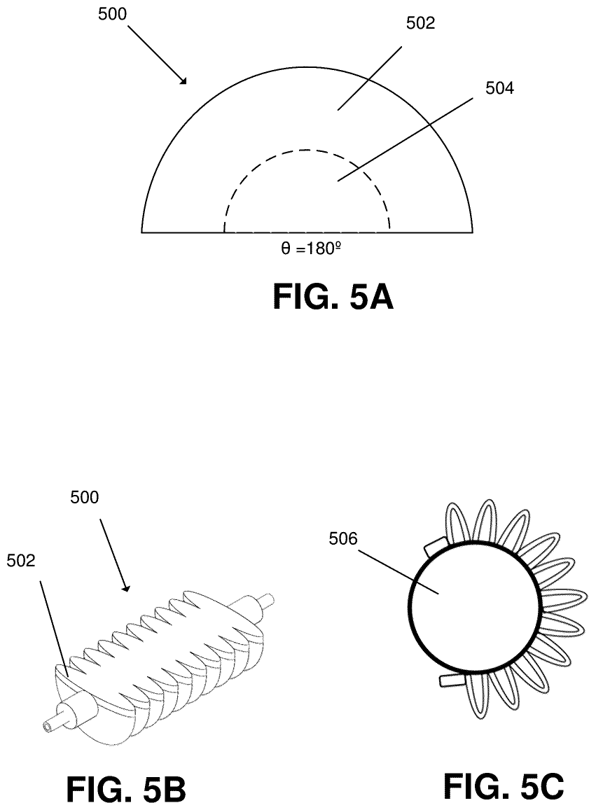

Referring to FIG. 5A, FIG. 5B and FIG. 5C, a bending section 500 is illustrated that comprises a plurality of bellows 502 that protrude radially from an elongated core 504 to define a spanning angle (θ) about a circumference of the elongated core 504. In the embodiment of FIG. 5A, the spanning angle (θ) is 180°. In other embodiments, the spanning angle (θ) is 180°±90°, or 180°±10°. In other embodiments, the spanning angle (θ) is at least 180° but less than 360°. As shown in FIG. 5C, when a fluid is added to the hollow interior, the plurality of bellows 502 bends about a perpendicular axis relative to the longitudinal axis, thereby gripping an object 506.

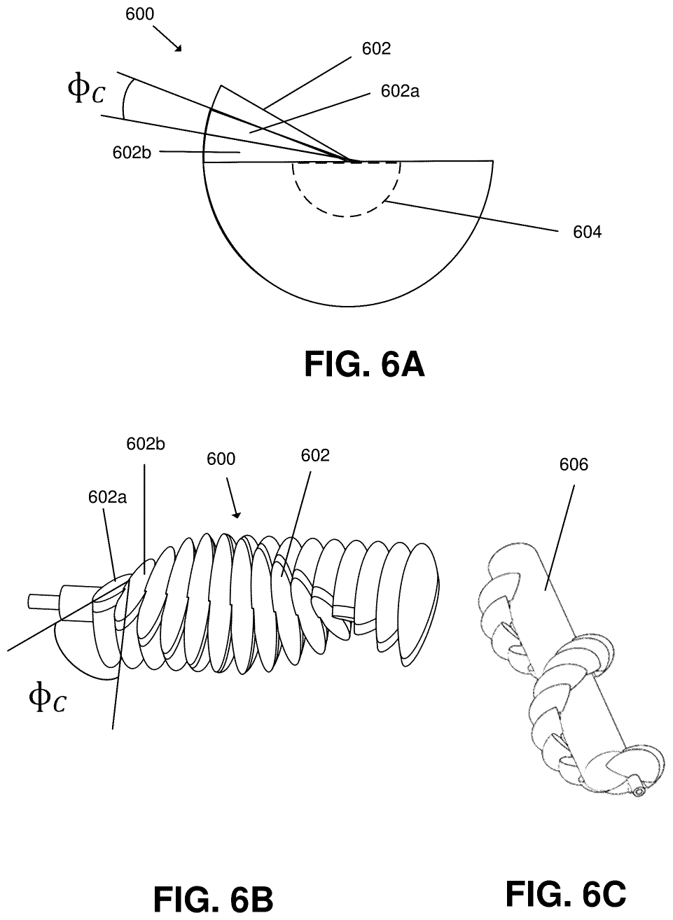

Referring to FIG. 6A, FIG. 6B and FIG. 6C, a curling section 600 is illustrated that comprises a plurality of bellows 602 that protrude radially from an elongated core 604 to define a spanning angle (θ) about a circumference of the elongated core 604 and a helical pattern with a curling angle ( [symbol] _{C}). For example, the plurality of bellows 602 comprises a first bellow 602a and a second bellow 602b that are adjacent. The first bellow 602a is angled relative to the second bellow 602b by a curling angle ( [symbol] _{C}) that is greater than 0° but less than 180°. In other embodiments, the curling angle ( [symbol] _{C}) is selected from the group consisting of 10°±5°, 20°±5°, 30°±5°, 35°±5°, 40°±5°, 45°±5° and 65°±5°.

In the embodiment of FIG. 6B, a plurality of bellows 602 that protrude radially from the elongated core 604 is shown in a perspective view with the spanning angle (θ) 180°. In other embodiments, the spanning angle (θ) is 180°±90° or 180°±10. As shown in FIG. 6C, when a fluid is added to the hollow interior, the plurality of bellows 602 curls along the longitudinal axis to grip an object 606.

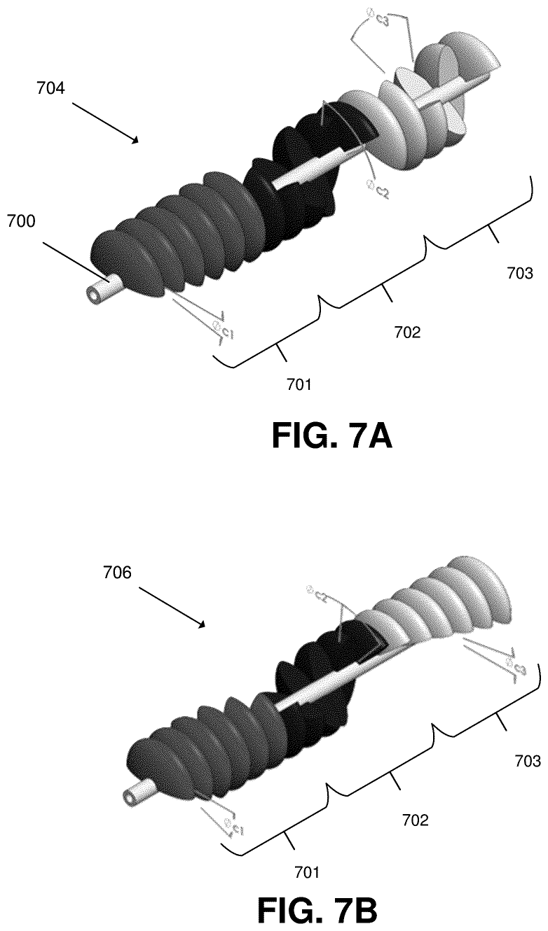

FIG. 7A depict one example of a spiraling section 704 that comprises three curling subsections, including a first subsection 701, a second subsection 702, and a third subsection 703, each of which comprises a plurality of bellows that protrude radially from an elongated core 700 to define a spanning angle (θ) about a circumference of the elongated core. The spanning angle (74 ) is greater than zero but less than 180°, 180°±90° or 180°±10. Each subsection 701, 702, 703 has a curling angle [symbol] _{C1}, [symbol] _{C2}, [symbol] _{C3}, respectively, which is different from the curling angle of an adjacent subsection.

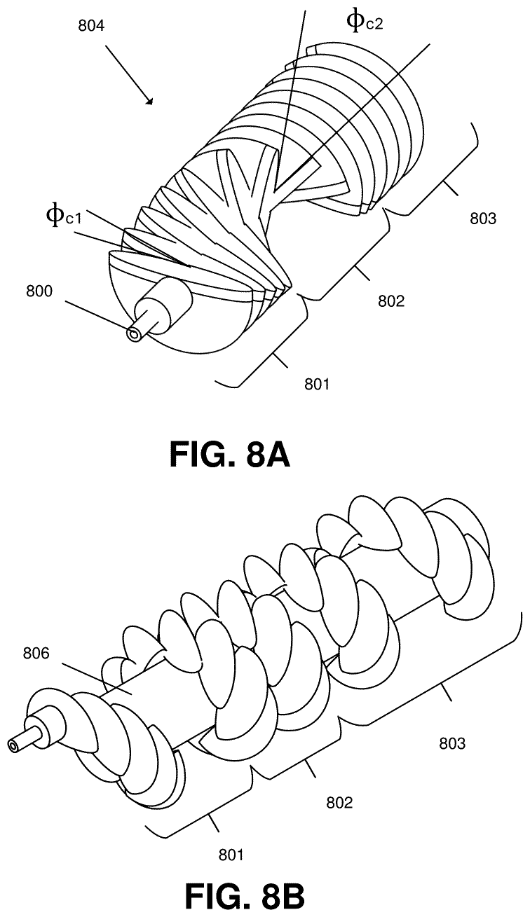

FIG. 7B depicts another example of a spiraling section 706 which is substantially similar to the spiraling section 704 except in that the third subsection 703 has a smaller curling angle ( [symbol] _{C3}) than the spiraling section 704. By using a spiraling section with different curling angles ( [symbol] _{C}), the spiraling motion is controlled. FIG. 8A and FIG. 8B provide an example of such control.

Referring to FIG. 8A, a spiraling section 804 is depicted. The spiraling section 804 comprises a first subsection 801 with a first curling angle ( [symbol] _{C1}), a second subsection 802 with a second curling angle ( [symbol] _{C2}) and a third subsection 803 with a third curling angle ( [symbol] _{C3}) (not shown). Each curling angle ( [symbol] _{C}) is independently chosen such that it is greater than 0° but less than 180°, or greater than 0° but less than 65°, provided at least two such curling angles ( [symbol] _{C}) are different in adjacent sections. Each curling angle ( [symbol] _{C}) may be selected to achieve different rate of curling to provide a spiraling gripping capability. In the embodiment of FIG. 8A, the second curling angle ( [symbol] _{C2}) is larger than the first curling angle ( [symbol] _{C1}) and the third curling angle ( [symbol] _{C3}). Referring to FIG. 8B, an object 806 is gripped by the spiraling section 804. The second subsection 802 produced a tightly curled section about the object 806, compared to the looser curled sections produced by the first subsection 801 and the third subsection 803.

In some embodiments, each curling angle ( [symbol] _{C}) is independently selected from the group consisting of 10°±5°, 20°±5°, 30°±5°, 35°±5°, 40°±5°, 45°±5° and 65°±5° provided at least two adjacent subsections have different curling angles ( [symbol] _{C}). The spiraling section 804 has curling angles ( [symbol] _{C}) that are non-uniform over its length. For example, the curling angle ( [symbol] _{C}) may be non-axisymmetric relative to the longitudinal axis over the length of the spiraling section 804. Thus, the angular arrangement of the bellow changes, relative to the other bellows in adjacent sections, over the longitudinal axis. In the embodiment of FIG. 7A, FIG. 7B, FIG. 8A and FIG. 8B three subsections are depicted. In other embodiments, two or more subsections may be presented, provided at least two adjacent subsections have a different curling angles ( [symbol] _{C}). The handedness of the helix is not particularly limited and may be right-handed or left-handed. Non-limiting examples of such embodiments are depicted in Table 1.

TABLE 1
Non-Limiting examples of curling angles (ϕ_{C})

| Embodiment | Curling angle (ϕ_{C}) |
|---|---|
| 1 | ϕ_{C1} = 10° ± 5°; ϕ_{C2} = 30° ± 5°; ϕ_{C3} = 10° ± 5° |
| 2 | ϕ_{C1} = 10° ± 5°; ϕ_{C2} = 20° ± 5°; ϕ_{C3} = 40° ± 5° |
| 3 | ϕ_{C1} = 10° ± 5°; ϕ_{C2} = 45° ± 5°; ϕ_{C3} = 60° ± 5°; |
| 4 | ϕ_{C1} = 20° ± 5°; ϕ_{C2} = 35° ± 5°; ϕ_{C3} = 10° ± 5° |

In the embodiment of FIG. 8A, the spanning angle (θ) is 180°. In other embodiments, the spanning angle (θ) is greater than zero but less than 180°, 180°±90° or 180°±10. As shown in FIG. 8B, when a fluid is added to the hollow interior, the spiraling section 804 spirals along the longitudinal axis.

In each of the aforementioned sections and subsections, the number of bellows that are present within each plurality of bellows is not particularly limited but provides control of the magnitude of the movement (expanding, bending, curling and/or spiraling). The number of bellows in each section may, for example, be from 1-20, from 1-100, from 1-10, from 4-20, from 4-10, from 6-10, from 6-8, etc.

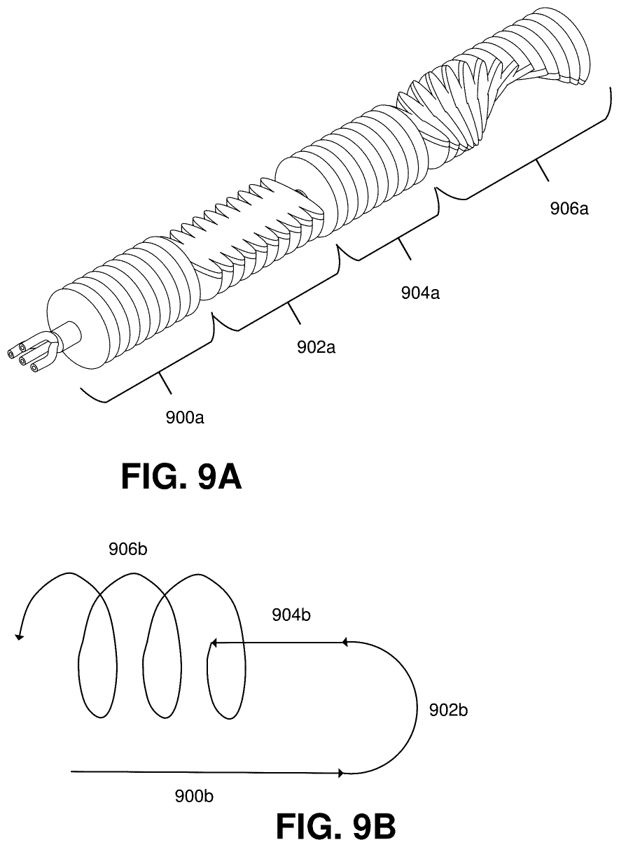

FIG. 9A and FIG. 9B depict one embodiment of multiple sections directly joined to produce specific movement patterns. FIG. 9A and FIG. 9B are provided to depict one example of a specific movement pattern. One of ordinary skill in the art, after benefitting from reading this disclosure, would recognize that other movement patterns are achieved by connecting different sections in a different order that provide for selective (i.e. independent) actuation. FIG. 9A and FIG. 9B specifically depict an expanding section 900a that produces expanding motion 900b, a bending section 902a that produces bending section 902b, an expanding section 904a that produces expanding motion 904b and a curling section 906a that produces curling motion 906b.

A variety of manufacturing processes may be utilized to produce the disclosed robotic gripping devices including, for example three-dimension (3D) printing, and molding.

The disclosed robotic gripping device is useful in a wide variety of applications. Non-limiting examples include as an integral part of a robotic system in an assembly line in a manufacturing environment, especially for delicate or odd-shaped products. The robotic gripping device may be the grabbing arm for an apparatus to perform challenging tasks such as gripping a stationary object external to the apparatus the disclosed robotic gripping device is attached to perform tasks such as rock-climbing or securing the apparatus in position, or picking up objects along the roadside as part of a highway maintenance apparatus, or gripping a target on an autonomous system to perform non-lethal restraining, etc.

The robotic gripping device can be incorporated into a fixed platform to grip a mobile object at a distance and bring the mobile object toward the platform. Alternatively, the robotic gripping device can be incorporated into a mobile platform to grip a fixed object and pull the mobile platform toward the fixed object. This embodiment can be used to secure the position of the platform or to pull the platform toward the fixed object. In another embodiment, the device is used to secure an object from continuous motion (e.g. wrapping around a moving object to prevent its further motion).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A robotic gripping device comprising:
an elongated core with a longitudinal axis, the elongated core being flexible;
a plurality of bellows protruding radially from the elongated core to define a spanning angle (θ) about a circumference of the elongated core, the plurality of bellows being flexible;
a fluid port; and
a hollow interior extending through the elongated core and into each bellow in the plurality of bellows, the hollow interior fluidly connected to the fluid port such that the hollow interior is inflated by adding fluid and deflated by removing fluid, thereby actuating the plurality of bellows.

2. The robotic gripping device as recited in claim 1, wherein the plurality of bellows protrudes radially such that the spanning angle (θ) is less than 360°.

3. The robotic gripping device as recited in claim 1, wherein the plurality of bellows protrudes radially such that the spanning angle (θ) is 360° wherein, when a fluid is added to the hollow interior, the plurality of bellows expands along the longitudinal axis.

4. The robotic gripping device as recited in claim 1, wherein the plurality of bellows protrudes radially such that the spanning angle (θ) is 180°±10° wherein, when a fluid is added to the hollow interior, the plurality of bellows bends perpendicular to the longitudinal axis.

5. The robotic gripping device as recited in claim 1, wherein the plurality of bellows protrudes radially such that the spanning angle (θ) is 180°±90° wherein, when a fluid is added to the hollow interior, the plurality of bellows bends relative to the longitudinal axis.

6. The robotic gripping device as recited in claim 1, wherein the plurality of bellows protrudes radially such that the spanning angle (θ) is 180°±90°, the plurality of bellows comprises a first bellow and a second bellow, the first bellow and the second bellow being adjacent, the first bellow being angled relative to the second bellow by a curling angle ( [symbol] _{C}) that is greater than 0° but less than 180°.

7. The robotic gripping device as recited in claim 1, wherein the plurality of bellows protrudes radially such that the spanning angle (θ) is or 180°±10°, the plurality of bellows comprises a first bellow and a second bellow, the first bellow and the second bellow being adjacent, the first bellow being angled relative to the second bellow by a curling angle ( [symbol] _{C}) that is greater than 0° but less than 180°.

8. The robotic gripping device as recited in claim 1, wherein the plurality of bellows protrudes radially such that the spanning angle (θ) is 180°±90°, the plurality of bellows comprises a first bellow and a second bellow, the first bellow and the second bellow being adjacent, the first bellow being angled relative to the second bellow by a curling angle ( [symbol] _{C}) that is greater than 0° but less than 180°, wherein, when a fluid is added to the hollow interior, the plurality of bellows curls along the longitudinal axis.

9. The robotic gripping device as recited in claim 1, wherein the plurality of bellows protrudes radially such that the spanning angle (θ) is 180°±10°, the plurality of bellows comprises a first bellow and a second bellow, the first bellow and the second bellow being adjacent, the first bellow being angled relative to the second bellow by a curling angle ( [symbol] _{C}) that is greater than 0° but less than 180°, wherein, when a fluid is added to the hollow interior, the plurality of bellows curls along the longitudinal axis.

10. The robotic gripping device as recited in claim 6, where the curling angle ( [symbol] _{C}) is selected from the group consisting of 10°±5°, 20°±5°, 30°±5°, 35°±5°, 40°±5°, 45°±5° and 65°±5°.

11. A device comprising a first robotic gripping device and a second robotic gripping device, each robotic gripping device comprising:
an elongated core with a longitudinal axis, the elongated core being flexible;
a plurality of bellows protruding radially from the elongated core to define a spanning angle about a circumference of the elongated core, the plurality of bellows being flexible;
a fluid port; and
a hollow interior extending through the elongated core and into each bellow in the plurality of bellows, the hollow interior fluidly connected to the fluid port such that the hollow interior is inflated by adding fluid and deflated by removing fluid, thereby actuating the plurality of bellows.

12. The device as recited in claim 11, wherein the plurality of bellows of the first robotic gripping device protrudes radially such that the spanning angle (θ) is 360°.

13. The device as recited in claim 11, wherein the first robotic gripping device has a first spanning angle (θ₁) and the second robotic gripping device has a second spanning angle (θ₂), wherein the first spanning angle (θ₁) and the second spanning angle (θ₂) are different.

14. The device as recited in claim 11, wherein the plurality of bellows of the first robotic gripping device protrudes radially such that the spanning angle (θ) is 180°±90°.

15. The device as recited in claim 14, wherein the first robotic gripping device is connected in series with the second robotic gripping device, the device configured to selectively inflate the first robotic gripping device, the second robotic gripping device, and combinations thereof.

16. The device as recited in claim 14, wherein the hollow interiors of the first robotic gripping device is directly connected to the hollow interior of the second robotic gripping device such that the hollow interiors of both the first robotic gripping device and the second robotic gripping device are simultaneously inflated or deflated by the fluid.

17. The device as recited in claim 16, wherein the plurality of bellows of the first robotic gripping device protrudes radially such that the spanning angle (θ) is 180°±90°, the plurality of bellows of the first robotic gripping device comprises a first bellow and a second bellow, the first bellow and the second bellow being adjacent, the first bellow being angled relative to the second bellow by a first curling angle ( [symbol] _{C1}) that is greater than 0° but less than 180°, wherein, when a fluid is added to the hollow interior, the plurality of bellows of the first robotic gripping device curls along the longitudinal axis.

18. The device as recited in claim 17, wherein the plurality of bellows of the second robotic gripping device protrudes radially such that the spanning angle (θ) is 180°±90°, the plurality of bellows of the second robotic gripping device comprises a third bellow and a fourth bellow, the third bellow and the fourth bellow being adjacent, the third bellow being angled relative to the fourth bellow by a second curling angle ( [symbol] _{C2}) that is greater than 0° but less than 180°, wherein, when a fluid is added to the hollow interior, the plurality of bellows of the second robotic gripping device curls along the longitudinal axis, and thereby causes the first robotic gripping device and the second robotic gripping device to spiral along the longitudinal axis.

19. A device comprising a first robotic gripping device, a second robotic gripping device and a third robotic gripping device, each robotic gripping device comprising:
an elongated core with a longitudinal axis, the elongated core being flexible;
a plurality of bellows protruding radially from the elongated core to define a spanning angle about a circumference of the elongated core, the plurality of bellows being flexible;
a fluid port; and
a hollow interior extending through the elongated core and into each bellow in the plurality of bellows, the hollow interior fluidly connected to the fluid port such that the hollow interior is inflated by adding fluid and deflated by removing fluid, thereby actuating the plurality of bellows;
wherein the hollow interiors of the first robotic gripping device, the second robotic gripping device and the third robotic gripping device are simultaneously inflated or deflated by the fluid.

20. The device as recited in claim 19, wherein the plurality of bellows of the first robotic gripping device protrudes radially such that the spanning angle (θ) is 180°±90°, the plurality of bellows of the first robotic gripping device comprises a first bellow and a second bellow, the first bellow and the second bellow being adjacent, the first bellow being angled relative to the second bellow by a first curling angle ( [symbol] _{C1}) that is greater than 0° but less than 180°, wherein, when a fluid is added to the hollow interior, the plurality of bellows of the first robotic gripping device curls along the longitudinal axis.

21. The device as recited in claim 20, wherein the plurality of bellows of the second robotic gripping device protrudes radially such that the spanning angle (θ) is 180°±90°, the plurality of bellows of the second robotic gripping device comprises a third bellow and a fourth bellow, the third bellow and the fourth bellow being adjacent, the third bellow being angled relative to the fourth bellow by a second curling angle ( [symbol] _{C2}) that is greater than 0° but less than 180°, wherein, when a fluid is added to the hollow interior, the plurality of bellows of the second robotic gripping device curls along the longitudinal axis, and thereby causes the first robotic gripping device and the second robotic gripping device to spiral along the longitudinal axis.

22. The device as recited in claim 21 wherein the plurality of bellows of the third robotic gripping device protrudes radially such that the spanning angle (θ) is 180°±90°, the plurality of bellows of the third robotic gripping device comprises a fifth bellow and a sixth bellow, the fifth bellow and the sixth bellow being adjacent, the fifth bellow being angled relative to the sixth bellow by a third curling angle ( [symbol] _{C3}) that is greater than 0° but less than 180°, wherein, when a fluid is added to the hollow interior, the plurality of bellows of the third robotic gripping device curls along the longitudinal axis, and thereby causes the first robotic gripping device and the second robotic gripping device to spiral along the longitudinal axis.

23. The device as recited in claim 22. wherein the first curling angle ( [symbol] _{C1}). the second curling angle ( [symbol] _{C2}) and the third the third curling angle ( [symbol] _{C3}) are selected from the group consisting of
$${C 1}_{} = 10 ° \pm 5 ° ; {C 2}_{} = 30 ° \pm 5 ° ; {C 3}_{} = 10 ° \pm 5 ° ; \\ {C 1}_{} = 10 ° \pm 5 ° ; {C 2}_{} = 20 ° \pm 5 ° ; {C 3}_{} = 40 ° \pm 5 ° ; \\ {C 1}_{} = 10 ° \pm 5 ° ; {C 2}_{} = 45 ° \pm 5 ° ; {C 3}_{} = 60 ° \pm 5 ° ; and \\ {C 1}_{} = 20 ° \pm 5 ° ; {C 2}_{} = 35 ° \pm 5 ° ; {C 3}_{} = 10 ° \pm 5 ° .$$
